(19) United States
(12) Patent Application Publication
(10) Pub. No.: US 2008/0117811 A1
(43) Pub. Date: May 22, 2008

(54) APPARATUS FOR TRANSMITTING AND RECEIVING DATA IN WIRELESS LOCAL NETWORK AND METHOD USING THE SAME

(75) Inventors: Chang Woo SEO, Yongin-si (KR); Jun Seo LEE, Yongin-si (KR); Jun Haeng CHO, Yongin-si (KR); Seung Hwan OH, Yongin-si (KR); Dong Won KWAK, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/858,625

(22) Filed: Sep. 20, 2007

(30) Foreign Application Priority Data
Nov. 22, 2006 (KR) 10-2006-0115748

(51) Int. Cl. H04L 12/56; H04Q 7/00

(52) U.S. Cl. 370/230

(57) ABSTRACT

An apparatus and method of receiving and transmitting data in a wireless local network is provided. An apparatus for receiving data in a wireless local network includes: a congestion determiner which determines whether there is a congestion in a buffer storing received data if the data is received via a prioritized contention access (PCA) period; and a congestion information transmitter which transmits, in the PCA period or a beacon period (BP), congestion generation information in a medium access control (MAC) frame or a beacon frame if there is the congestion in the buffer.

### CROSS-REFERENCE TO RELATED APPLICATION

This application claims priority from Korean Patent Application No. 10-2006-0115748, filed on Nov. 22, 2006, in the Korean Intellectual Property Office, the entire disclosure of which is incorporated herein by reference.

### BACKGROUND OF THE INVENTION

1. Field of the Invention

Methods and apparatuses consistent with the present invention relate to data transmission/reception, and more particularly, to an apparatus and method of transmitting and receiving data in a wireless local network, which can improve transmission efficiency of the data via a prioritized contention access (PCA) period in a wireless multimedia medium access control (WiMedia MAC) corresponding to a wireless local network.

2. Description of Related Art

Generally, a beacon group corresponding to a local wireless network simply includes wireless multimedia (WiMedia) devices without a coordinator controlling a device. Specifically, it is required that the devices included in the beacon group should retrieve, generate, and maintain superframe (SF) synchronization.

A SF includes a beacon period (BP) including a beacon with respect to the devices included in the beacon group, and a data period (DP) related to data transmission/reception.

The data transmission/reception between the devices is made in a distributed reservation protocol (DRP) method and a prioritized contention access (PCA) method.

According to the DRP method, a device receiving data determines a request permission, based on a reservation status in the beacon group, and a status of a corresponding device when a device transmitting data requests a reservation. Specifically, a DRP period corresponds to an uncompetitive period, and negotiates, in advance, a transmission amount for each traffic flow between a transmitting device and a receiving device.

According to the PCA method, the devices compete in a transmission opportunity (TXOP) period, and a device obtaining a medium may transmit data. Specifically, a PCA period corresponds to a competitive period, and does not negotiate, in advance, a transmission amount for each traffic flow between a transmitting device and a receiving device.

Data transmission between the transmitting device and the receiving device via the PCA period indicates that the transmitting device transmits the data to the receiving device, and transmits next data to the receiving device when an acknowledgment (ACK) signal transmitted from the receiving device is received.

The receiving device does not transmit the ACK signal to the transmitting device which transmits the data when there is a bit error in the received data, or congestion of a receiving buffer in the receiving device is generated.

The transmitted data is retransmitted to the receiving device when the transmitting device does not receive the ACK signal from the receiving device. Specifically, since the transmitting device may not be able to identify whether the bit error is generated in the data transmitted to the receiving device, or congestion of the receiving buffer in the receiving device is generated when the transmitting device does not receive the ACK signal from the receiving device, the transmitted data is retransmitted to the receiving device.

However, since the data is also retransmitted to the receiving device for a predetermined period of time when the transmitting device may not receive the ACK signal due to congestion generation of the receiving buffer in the receiving device, a packet error rate (PER) is high, although a bit error rate (BER) is low. Accordingly, there is a problem that entire medium access control (MAC) transmission efficiency of a beacon group is reduced.

Also, since the transmitting device retransmits the data to the receiving device for a predetermined period of time in spite of a state where the receiving device may not receive the data, there is a problem that power due to data retransmission is consumed, and a band of the SF is consumed.

Therefore, an apparatus in which a transmitting device can check whether congestion of a receiving buffer in a receiving device is generated, and which can improve transmission efficiency of data, is required.

### SUMMARY OF THE INVENTION

The present invention provides an apparatus and method of transmitting and receiving data in a wireless local network, in which a receiving device for receiving the data can transmit congestion generation information when congestion of a receiving buffer is generated, and the receiving device can transmit congestion generation release information when congestion generation of the receiving buffer is released.

The present invention also provides an apparatus and method of transmitting and receiving data in a wireless local network, in which a transmitting device can receive congestion generation information from a receiving device, stop transmission of the data to the receiving device, and transmit the data to another receiving device, thereby reducing a packet error rate (PER) and increasing entire medium access control (MAC) transmission efficiency of a beacon group.

The present invention also provides an apparatus and method of transmitting and receiving data in a wireless local network, in which a transmitting device can receive congestion generation release information from a receiving device, and retransmit the data, the transmission of the data having been previously stopped, to the receiving device.

The present invention also provides an apparatus and method of transmitting and receiving data in a wireless local network, in which a transmitting device can control transmission of the data to a receiving device via either congestion generation information or congestion generation release information which is received from the receiving device, thereby reducing unnecessary power consumption of the transmitting device.

According to an aspect of the present invention, there is provided an apparatus for receiving data in a wireless local network including: a congestion determiner which determines whether there is a congestion in a buffer storing received data if the data is received via a prioritized contention access (PCA) period; and a congestion information transmitter which transmits, in the PCA period or a beacon period (BP), congestion generation information in either a MAC frame or a beacon frame if there is the congestion in the buffer.

In this instance, the congestion information transmitter may transmit the congestion generation information in a MAC control frame to the PCA period.

In this instance, the congestion information transmitter may transmit the congestion generation information in a MAC command frame in the PCA period.

In this instance, the congestion information transmitter may transmit the congestion generation information in the beacon frame where media access slot (MAS) information is removed from a PCA availability information element.

In this instance, the congestion information transmitter may transmit congestion generation release information if the congestion in the buffer is released.

In this instance, the congestion information transmitter may transmit, in the PCA period or the BP, the congestion generation release information in the MAC frame or the beacon frame.

In this instance, the congestion information transmitter may transmit the congestion generation release information in the beacon frame where MAS information is removed from a PCA availability information element.

According to another aspect of the present invention, there is provided an apparatus for transmitting data in a wireless local network including: a congestion information determiner which determines whether there is a congestion in a buffer, based on congestion information of the buffer configured in a receiving device of data, which is received via a prioritized contention access (PCA) period or a beacon; and a data transmission manager which stops transmission of the data to the receiving device if there is the congestion in the buffer is generated, and transmits the data being transmitted to another receiving device, via the PCA period.

In this instance, the data transmission manager may retransmit the data to the receiving device of the data if the received congestion information corresponds to information indicating release of the congestion generation in the buffer.

According to still another aspect of the present invention, there is provided a method of receiving data in a wireless local network including: determining whether there is a congestion in a buffer storing received data if the received data is received via a prioritized contention access (PCA) period; and transmitting, in the PCA period or a beacon period (BP), congestion generation information in a medium access control (MAC) frame or a beacon frame of a receiving device if there is the congestion in the buffer.

According to yet another aspect of the present invention, there is provided a method of transmitting data in a wireless local network, the method including: determining whether there is a congestion in a buffer, based on congestion information of the buffer configured in a receiving device of data which is received via a prioritized contention access (PCA) period or a beacon; stopping transmission of the data to the receiving device if there is the congestion in the buffer; and transmitting the data, being transmitted to another receiving device, via the PCA period.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration of a receiving device for receiving data in a wireless local network according to an exemplary embodiment of the present invention;

FIG. 2 is a block diagram illustrating a configuration of a transmitting device for transmitting data in a wireless local network according to an exemplary embodiment of the present invention;

FIG. 3 is a diagram illustrating data transmission/reception between devices in a beacon group according to an exemplary embodiment of the present invention;

FIG. 4 is a diagram illustrating a process of the data transmission/reception between the devices in the beacon group illustrated in FIG. 3;

FIG. 5 is a flowchart illustrating an operation of a method of receiving data in a wireless local network according to an exemplary embodiment of the present invention; and

FIG. 6 is a flowchart illustrating an operation of a method of transmitting data in a wireless local network according to an exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

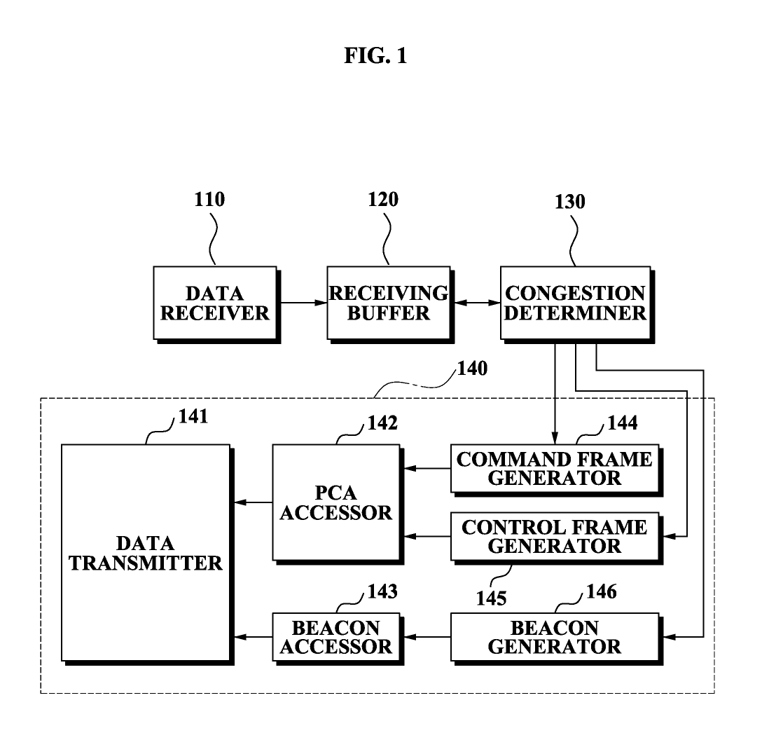

FIG. 1 is a block diagram illustrating a configuration of a receiving device for receiving data in a wireless local network according to an exemplary embodiment of the present invention.

Referring to FIG. 1, the receiving device includes a data receiver 110, a receiving buffer 120, a congestion determiner 130, and a congestion information transmitter 140.

The data receiver 110 receives the data which is transmitted via a prioritized contention access (PCA) period from another device in a beacon group.

In this instance, the data which the data receiver 110 receives may be stored in the receiving buffer 120.

In this instance, when there is congestion in the receiving buffer 120, the data received at the data receiver 110 may be discarded.

The congestion determiner 130 determines whether there is congestion in the receiving buffer 120.

Specifically, the receiving buffer 120 determines whether the data which the data receiver 110 receives may be stored.

In this instance, the congestion determiner 130 may generate congestion generation information if there is congestion in the receiving buffer 120.

In this instance, the congestion determiner 130 may generate congestion generation release information if the congestion in the receiving buffer 120 is released, i.e., if congestion is no longer present in the receiving buffer 120.

In this instance, the congestion generation release information may include a buffer level of the receiving buffer 120. For example, a level is established according to a storage area which the receiving buffer 120 may use, and the level corresponding to the storage area which may be used is included in the congestion generation release information.

In this instance, the congestion generation information or the congestion generation release information may be configured of a type length value (TLV) format.

The congestion information transmitter 140 transmits during either the PCA period or a beacon period (BP), either the inputted congestion generation information or the inputted congestion generation release information, i.e., congestion information, in either a medium access control (MAC) frame or a beacon frame of the receiving device when either the congestion generation information or the congestion generation release information is inputted from the congestion determiner 130.

The congestion information transmitter 140 includes a command frame generator 144, a control frame generator 145, a beacon generator 146, a PCA accessor 142, a beacon accessor 143, and a data transmitter 141.

The command frame generator 144 generates a MAC command frame including either the congestion generation information or the congestion generation release information.

The control frame generator 145 generates a MAC control frame including either the congestion generation information or the congestion generation release information.

The beacon generator 146 generates a beacon of the receiving device including either the congestion generation information or the congestion generation release information.

In this instance, the beacon generator 146 may generate the beacon where media access slot (MAS) information of a receiving device is removed from a PCA availability information element.

The PCA accessor 142 enables the MAC command frame and the MAC control frame including the congestion information to be transmitted in the PCA period.

The beacon accessor 143 enables the beacon including either the congestion generation information or the congestion generation release information to be transmitted to a beacon slot of the receiving device.

The data transmitter 141 transmits either the MAC command frame or the MAC control frame via the PCA period, and transmits the beacon including the congestion information to the beacon slot of the receiving device in the BP.

Here, either the MAC command frame or the MAC control frame including the congestion generation information which is transmitted via the PCA period is transmitted to the transmitting device which transmits the data.

Here, the beacon including the congestion information which is transmitted via the beacon slot of the receiving device in the BP is transmitted to the transmitting device which transmits the data, and all devices configured in the beacon group. Specifically, since all the devices configured in the beacon group receive the beacon, all the devices may be aware of either the congestion generation information or the congestion generation release information.

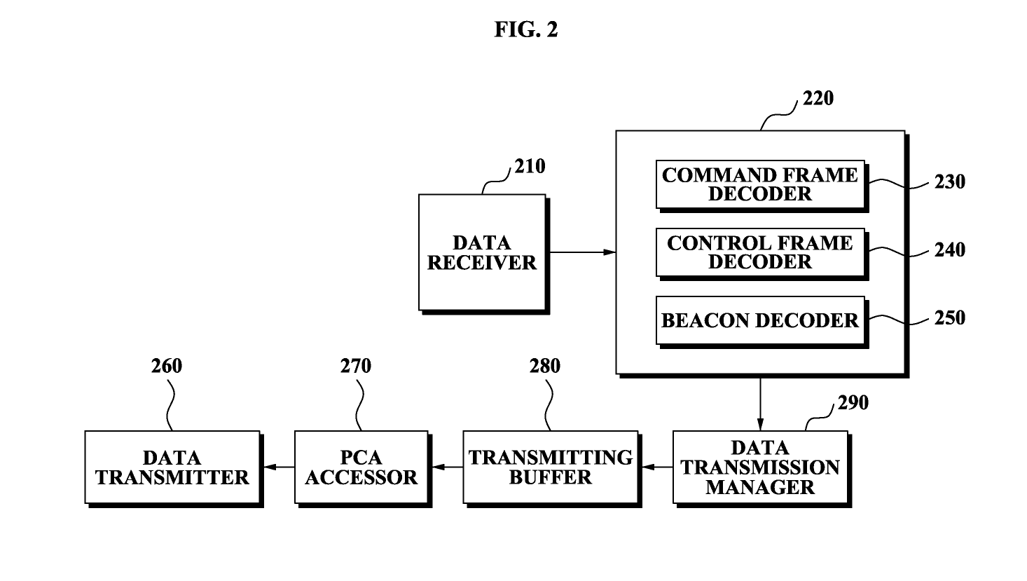

FIG. 2 is a block diagram illustrating a configuration of a transmitting device for transmitting data in a wireless local network according to an exemplary embodiment of the present invention.

Referring to FIG. 2, the transmitting device includes a data receiver 210, a congestion information determiner 220, a data transmitter 260, a PCA accessor 270, a transmitting buffer 280, and a data transmission manager 290.

The data receiver 210 receives, via either the PCA period or beacon period, the congestion information of the receiving buffer configured in the receiving device of the data.

The congestion information determiner 220 determines whether there is congestion in the receiving buffer configured in the receiving device, based on congestion information which is received via either the PCA period or the beacon period.

The congestion information determiner 220 includes a command frame decoder 230, a control frame decoder 240, and a beacon decoder 250.

The command frame decoder 230 decodes the MAC command frame which is received via the PCA period, and determines whether, in the receiving buffer configured in the receiving device of the data, there is congestion or there has been a release of congestion, based on the congestion information which is included in the MAC command frame.

The control frame decoder 240 decodes the MAC control frame which is received via the PCA period, and determines whether, in the receiving buffer configured in the receiving device of the data, there is congestion or there has been a release of congestion, based on the congestion information which is included in the MAC control frame.

The beacon decoder 250 decodes the beacon of the receiving device of the data which is included in the BP, and determines whether, in the receiving buffer configured in the receiving device of the data, there is congestion or there has been a release of congestion, based on the congestion information which is included in the beacon of the receiving device of the data.

The data transmission manager 290 stops transmission of the data, being transmitted to the receiving device of the data, when the congestion generation information is inputted from the congestion information determiner 220, and retransmits the data, the transmission of the data having been previously stopped, to the receiving device of the data when the congestion generation release information is inputted from the congestion information determiner 220.

Also, the data transmission manager 290 enables the data, for transmitting to another receiving device, to be transmitted when the congestion generation information is inputted from the congestion information determiner 220, and the data, for transmitting to the other receiving device, exists.

The PCA accessor 270 enables the data, for transmitting to the other receiving device and being stored in the transmitting buffer 280, to be transmitted in the PCA period.

The data transmitter 260 transmits the data, for transmitting to the other receiving device, via the PCA period to the other receiving device.

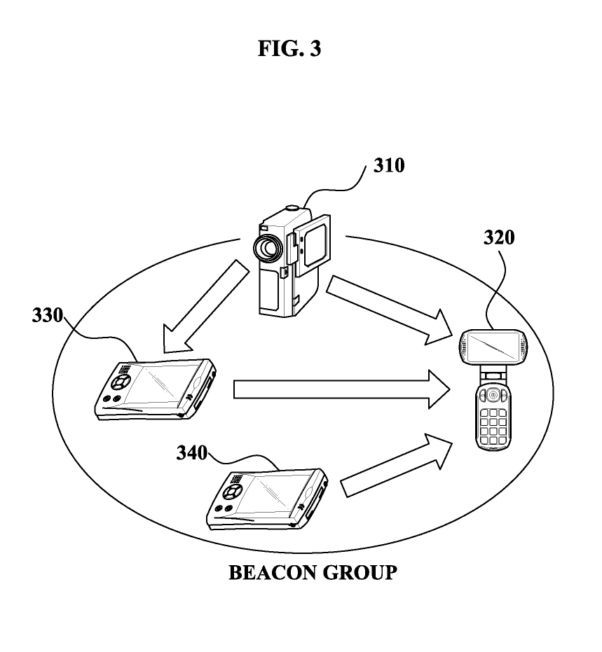

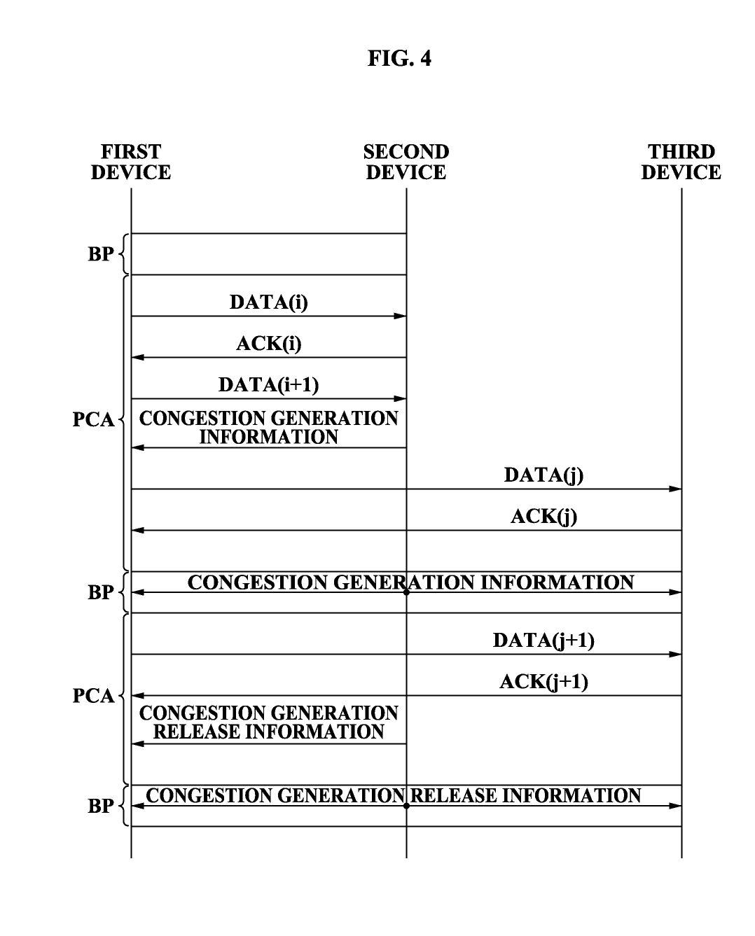

A device for transmitting and receiving data in a wireless local network according to an exemplary embodiment of the present invention is described with reference to FIGS. 3 and 4.

FIG. 3 is a diagram illustrating data transmission/reception between devices in a beacon group according to an exemplary embodiment of the present invention.

FIG. 4 is a diagram illustrating a process of the data transmission/reception between the devices in the beacon group illustrated in FIG. 3.

Here, FIG. 4 simply illustrates a BP and a PCA period excluding a distributed reservation protocol (DRP) period.

Referring to FIG. 3, a beacon group includes four devices 310 through 340, a second device 320 receives data from a first device 310, a third device 330, and a fourth device 340, and the first device 310 transmits the data to the second device 320 and the third device 330.

Here, it is assumed that the second device 320 receives, via a PCA period, the data which is transmitted from the first device 310, and congestion in a receiving buffer occurs when receiving the data which is transmitted from the first device 310.

Referring to FIG. 4, the first device transmits data(i) via a PCA period to the second device.

The second device stores the data(i) in the receiving buffer after receiving the data(i), and transmits an ACK(i) signal to the first device.

The first device transmits next data(i+1) via the PCA period to the second device.

The second device generates congestion generation information when there is congestion in the receiving buffer, and transmits the congestion generation information via the PCA period to the first device.

In this instance, the second device may transmit, via the PCA period, to the first device, a MAC command frame including the congestion generation information generated by the command frame generator.

In this instance, the second device may transmit, via the PCA period to the first device, the MAC control frame including the congestion generation information generated by a control frame generator.

The first device receives the congestion generation information which is transmitted from the second device, stops transmission of the data, being transmitted to the second device, and transmits data(j) to the third device, which exists and is able to receive the transmitted data(j).

The second device where there is congestion in the receiving buffer, transmits the beacon of the second device including the congestion generation information via the beacon slot of the second device configured in the BP. Specifically, the first device, the third device, and the fourth device may recognize via the congestion generation information which is included in the beacon slot of the second device that there is congestion in the receiving buffer in the second device.

The second device generates the congestion generation release information, and transmits the congestion generation release information included in either the PCA period or the beacon of the second device when congestion generation of the receiving buffer in the second device is released during a period of time in which the first device is transmitting the data to the third device.

In this instance, the second device may transmit, via the PCA period to the first device, either the MAC command frame or the MAC control frame including the congestion generation release information.

In this instance, the second device transmits the congestion generation release information via the beacon of the second device, and enables the first device, the third device, and the fourth device to receive the congestion generation release information and recognize that congestion in the receiving buffer in the second device is released.

The first device receives the congestion generation release information which is transmitted from the second device, and retransmits the data, the transmission of the data having been previously stopped, to the first device.

Similar to the description above, according to the present invention, the receiving device may transmit the congestion generation information and the congestion generation release information of the receiving buffer to either a specific transmitting device or all devices configured in the beacon group, and prevent the transmitting device from transmitting unnecessary data.

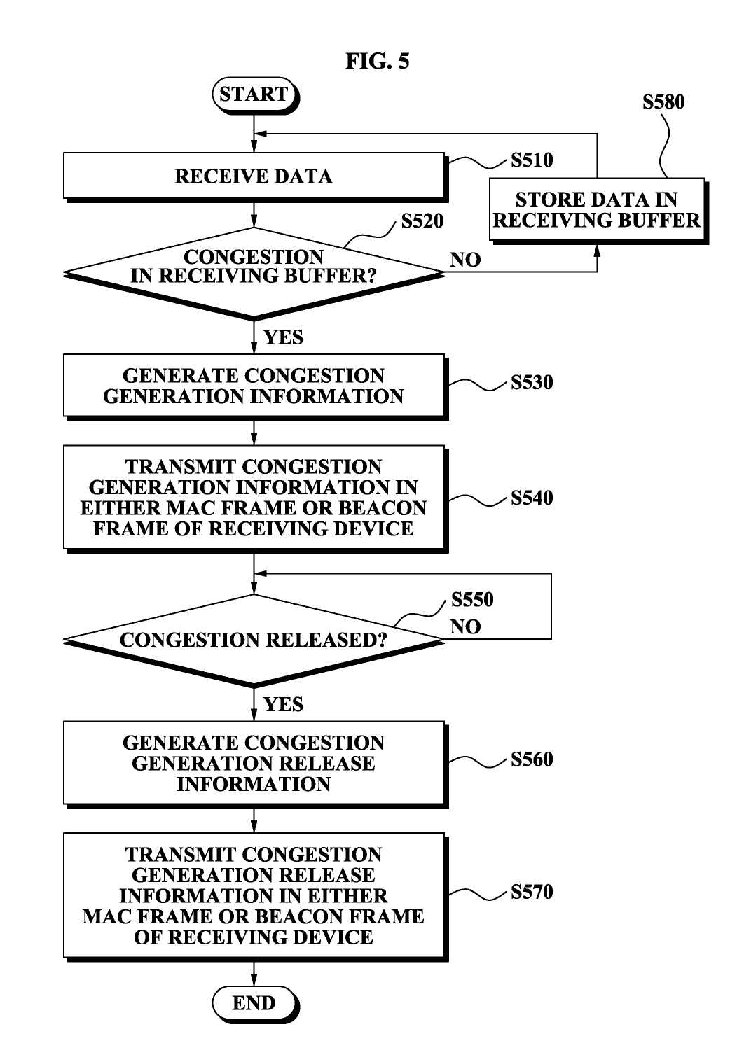

FIG. 5 is a flowchart illustrating an operation of a method of receiving data in a wireless local network according to an exemplary embodiment of the present invention.

Referring to FIG. 5, a receiving device receives the data which is transmitted via a PCA period (S510), and determines whether the received data may be stored in a receiving buffer, and whether there is congestion in the receiving buffer (S520).

The congestion generation information is generated when there is congestion in the receiving buffer (S530), and the generated congestion generation information in either a MAC frame or a beacon frame of a receiving device, is transmitted in either the PCA period or a BP (S540).

In this instance, the congestion generation information may be included in the MAC command frame, and be transmitted via the PCA period to the device which transmits the data.

In this instance, the congestion generation information may be included in the MAC control frame, and be transmitted via the PCA period to the device which transmits the data.

In this instance, the congestion generation information may be included in the beacon of the receiving device where MAS information of the receiving device is removed from a PCA availability information element, and be transmitted to all devices in the beacon group.

Conversely, when there is no congestion in the receiving buffer, the data which is received via the PCA period is stored in the receiving buffer, and next data is received (S580).

The device where there is congestion in the receiving buffer, determines whether the congestion in the receiving buffer is released (S550), and generates the congestion generation release information when the congestion is released (S560).

In this instance, the device may determine, at predetermined intervals, whether congestion in the receiving buffer is released.

In this instance, the MAC control frame including the congestion generation release information may include a buffer level of the receiving buffer.

The device transmits, in either the PCA period or the BP, the generated congestion generation release information in either the MAC frame or the beacon frame of the receiving device (S570).

In this instance, the congestion generation release information may be included in the MAC command frame, and be transmitted via the PCA period to the device which transmits the data.

In this instance, the congestion generation release information may be included in the MAC control frame, and be transmitted via the PCA period to the device which transmits the data.

In this instance, the congestion generation release information may be included in the beacon of the receiving device where the MAS information of the receiving device is removed from the PCA availability information element, and be transmitted to all the devices in the beacon group.

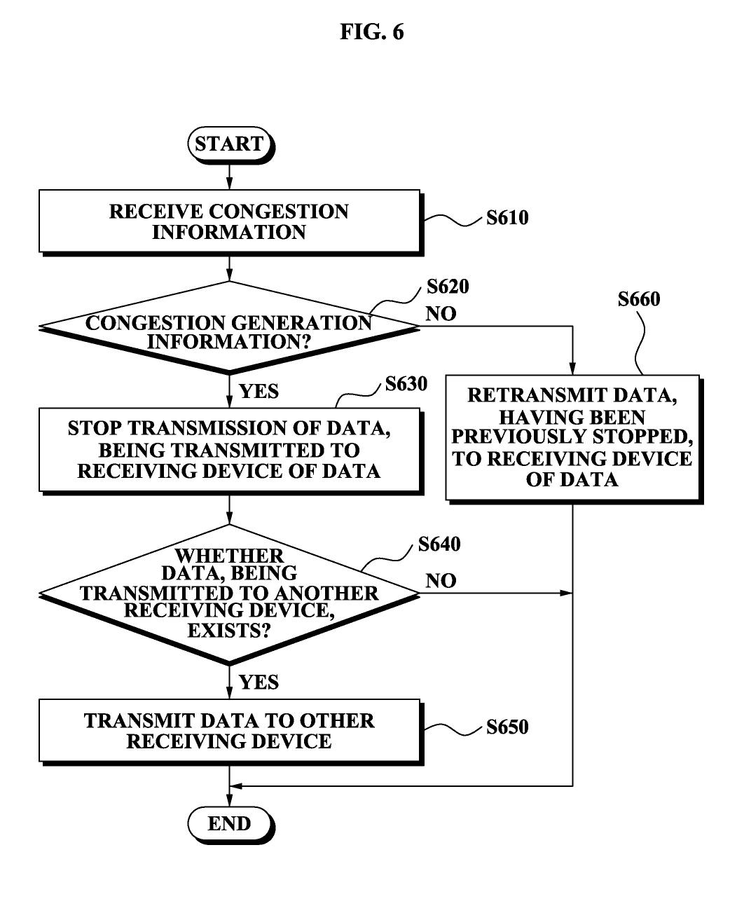

FIG. 6 is a flowchart illustrating an operation of a method of transmitting data in a wireless local network according to an exemplary embodiment of the present invention.

Referring to FIG. 6, a device receives congestion information via a beacon included in either a PCA period or a BP (S610), and determines whether the received congestion information corresponds to congestion generation information of a receiving buffer configured in the receiving device of the data (S620).

Specifically, whether congestion in the receiving buffer configured in the receiving device of the data, exists, or congestion is released after congestion, is determined.

In this instance, whether the congestion information is received may be determined by whether the congestion information is included in either the MAC command frame or the MAC control frame which is received via the PCA period, or whether the congestion information is included in the beacon which is included in the BP.

For example, whether the congestion information corresponds to either the congestion generation information or the congestion generation release information may be determined by comparing a specific field value which is included in the congestion information, and predetermined values respectively corresponding to the congestion generation information and the congestion generation release information.

When the congestion information corresponds to the congestion generation information, transmission of the data, being transmitted to the receiving device of the data if there is congestion in the receiving buffer, is stopped (S630), and whether the data, for transmitting to another receiving device configured in the beacon group, exists is determined (S640).

When the data, for transmitting to the other receiving device of the data, exists, the data is transmitted via the PCA period to the other receiving device (S650).

Conversely, the data, having been previously stopped, is retransmitted to the receiving device of the data, if there is congestion in the receiving buffer, via the PCA period when the received congestion information corresponds to the congestion generation release information, resulting from the determining in operation S620 (S660).

FIG. 6 is the flowchart illustrating the operation of the device which transmits the data via the PCA period to the receiving device of the data if there is congestion in the receiving buffer. Accordingly, any one of the other devices configured in the beacon group transmits the data to the other device excluding the receiving device of the data where there is congestion, based on the received congestion generation information when the congestion generation information is received from the receiving device of the data if there is congestion in the receiving buffer, via the BP.

Similar to the description above, the transmitting device according to the present invention may control transmission of the data with the devices configured in the beacon group via the PCA period, based on whether there is congestion in the receiving buffer in the receiving device which is received via the PCA period or the beacon.

A method of transmitting and receiving data in a wireless local network according to the above-described exemplary embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the present invention, there is provided an apparatus and method of transmitting and receiving data in a wireless local network, in which a receiving device for receiving the data can transmit congestion generation information when there is congestion in a receiving buffer, and the receiving device can transmit congestion generation release information when the congestion in the receiving buffer is released.

According to the present invention, there is provided an apparatus and method of transmitting and receiving data in a wireless local network, in which a transmitting device can receive congestion generation information from a receiving device, stop transmission of the data to the receiving device, and transmit the data to another receiving device, thereby reducing a packet error rate (PER) and increasing entire MAC transmission efficiency of a beacon group.

According to the present invention, there is provided an apparatus and method of transmitting and receiving data in a wireless local network, in which a transmitting device can receive congestion generation release information from a receiving device, and retransmit the data, the transmission of the data having been previously stopped, to the receiving device.

According to the present invention, there is provided an apparatus and method of transmitting and receiving data in a wireless local network, in which a transmitting device can control transmission of the data to a receiving device via either congestion generation information or congestion generation release information which is received from the receiving device, thereby reducing unnecessary power consumption of the transmitting device.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for receiving data in a wireless local network comprising:
a congestion determiner which determines whether there is a congestion in a buffer storing received data if the data is received via a prioritized contention access (PCA) period; and
a congestion information transmitter which transmits in the PCA period or a beacon period (BP), congestion generation information in a medium access control (MAC) frame or a beacon frame if there is the congestion in the buffer.

2. The apparatus of claim 1, wherein the congestion information transmitter transmits the congestion generation information in a MAC control frame in the PCA period.

3. The apparatus of claim 1, wherein the congestion information transmitter transmits the congestion generation information in a MAC command frame in the PCA period.

4. The apparatus of claim 1, wherein the congestion information transmitter transmits the congestion generation information in the beacon frame where media access slot (MAS) information is removed from a PCA availability information element.

5. The apparatus of claim 1, wherein the congestion information transmitter transmits congestion generation release information if the congestion in the buffer is released.

6. The apparatus of claim 5, wherein the congestion information transmitter transmits, in the PCA period or the BP, the congestion generation release information in the MAC frame or the beacon frame.

7. The apparatus of claim 6, wherein the congestion information transmitter transmits the congestion generation release information in the beacon frame where MAS information is removed from a PCA availability information element.

8. An apparatus for transmitting data in a wireless local network comprising:
a congestion information determiner which determines whether there is a congestion in a buffer, based on congestion information of the buffer configured in a receiving device of data, which is received via a prioritized contention access (PCA) period or a beacon; and
a data transmission manager which stops transmission of the data to the receiving device if there is the congestion in the buffer, and transmits the data being transmitted to another receiving device, via the PCA period.

9. The apparatus of claim 8, wherein the data transmission manager retransmits the data to the receiving device of the data if the received congestion information corresponds to information indicating release of the congestion in the buffer.

10. A method of receiving data in a wireless local network comprising:
determining whether there is a congestion in a buffer storing received data if the received data is received via a prioritized contention access (PCA) period; and
transmitting, in the PCA period or a beacon period (BP), congestion generation information in a medium access control (MAC) frame or a beacon frame of a receiving device if there is the congestion in the buffer.

11. The method of claim 10, wherein the transmitting of the congestion generation information in the MAC frame or the beacon frame of the receiving device, transmits the congestion generation information in a MAC control frame in the PCA period.

12. The method of claim 10, wherein the transmitting of the congestion generation information in the MAC frame or the beacon frame of the receiving device, transmits the congestion generation information in a MAC command frame in the PCA period.

13. The method of claim 10, wherein the transmitting of the congestion generation information in the MAC frame or the beacon frame of the receiving device, transmits the congestion generation information in the beacon frame of the receiving device where media access slot (MAS) information of a receiving device is removed from a PCA availability information element.

14. The method of claim 10 further comprising:
transmitting congestion generation release information if the congestion in the buffer is released.

15. The method of claim 14, wherein the transmitting of the congestion generation release information transmits, in the PCA period or the BP, the congestion generation release information in the MAC frame or the beacon frame of the receiving device.

16. The method of claim 15, wherein the transmitting of the congestion generation release information transmits the congestion generation release information in the beacon frame of the receiving device where media access slot (MAS) information of a receiving device is removed from a PCA availability information element.

17. A method of transmitting data in a wireless local network, the method comprising:
determining whether there is a congestion in a buffer, based on congestion information of the buffer configured in a receiving device of data which is received via a prioritized contention access (PCA) period or a beacon;
stopping transmission of the data to the receiving device if there is the congestion in the buffer; and
transmitting the data, being transmitted to another receiving device, via the PCA period.

18. The method of claim 17 further comprising:
retransmitting the data to the receiving device of the data if the received congestion information corresponds to information indicating a release of the congestion in the buffer.

19. A computer-readable recording medium storing a program for implementing the method according to claim 10.
